(19) United States
(12) Patent Application Publication
(10) Pub. No.: US 2005/0003851 A1
(43) Pub. Date: Jan. 6, 2005

(54) Radio system with touch pad interface

(75) Inventors: Michael Chrysochoos, Toledo, OH (US); John T. Kosinski II, River Rouge, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/858,907

(22) Filed: Jun. 2, 2004

Related U.S. Application Data
(60) Provisional application No. 60/475,972, filed on Jun. 5, 2003.

(51) Int. Cl. G09G 5/00

(52) U.S. Cl. 455/550.1

(57) ABSTRACT

The present invention provides a radio system for portable use. The radio system includes a radio tuner, a display, and a touch pad. The radio tuner is configured to receive radio transmissions. The display is in communication with the radio tuner to display transmission information, radio commands, or input from the touch pad. The touch pad is configured to sense gestures on the surface of the touch pad. Further, the radio tuner is capable of executing radio control commands in response to each of the gestures.

### BACKGROUND

1. Field of the Invention

The present invention generally relates to an improved radio interface.

2. Description of Related Art

Mobile and portable radios have been available to the public for many years. As technology has progressed, the size of portable radios has dramatically decreased. However, at the same time, available functions and station selections for the radio have dramatically increased. With the decrease in size of portable radios and the increase in functionality, designing effective user interfaces has become increasingly important and difficult. Often, portable radio devices will use very small buttons, which are difficult to manipulate. Alternatively, radio systems may use multiple combinations of buttons to support the growing number of radio control commands. Now more than ever, with the increased functionality and number of stations available through the introduction of satellite radio, the use of portable systems have become increasingly difficult.

In view of the above, it is apparent that there exists a need for an improved radio interface.

### SUMMARY

In satisfying the above need, as well as, overcoming the enumerated drawbacks and other limitations of the related art, the present invention provides a radio system with an improved interface for portable use.

The radio system includes a radio tuner, a display, and a touch pad. The radio tuner is configured to receive radio transmissions and generate corresponding audio signals. The display is in communication with the radio tuner to display transmission information, radio control commands, or input from the touch pad. The touch pad is configured to sense gestures on a surface of the touch pad. Further, the radio tuner is capable of executing radio control commands in response to each of the gestures.

In another aspect of the present invention, the touch pad is configured to recognize gestures to advance to the next or a previous station, access a memory preset, or adjust the volume of the radio tuner. In addition, gestures may be used to enter or exit seek mode, lock or unlock the touch pad, or change the control orientation of the touch pad.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a plan view of a radio interface in accordance with the present invention.

### DETAILED DESCRIPTION

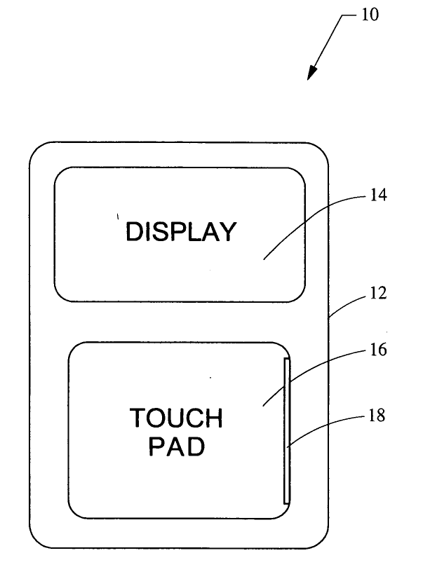

Referring now to FIG. 1, a system embodying the principles of the present invention is illustrated therein and designated at 10. The system 10 includes a radio receiver 12, a display 14, and a touch pad 16.

The radio tuner 12 is configured to receive radio transmissions and generate an audio signal based on the radio transmissions. The radio tuner 12 may be capable of receiving AM, FM, satellite, or other forms of radio transmissions. The display 14 is in electrical communication with the radio tuner 12 for displaying information regarding the radio transmission, the function of the radio tuner 12, or the input received by the touch pad 16.

The touch pad 16 is a device configured to sense and interpret a path created on a surface of the touch pad (a “gesture”), typically by the user's finger. In one implementation, the touch pad contains several layers of material. The top layer is the surface that the user touches. Beneath the surface are layers, separated by very thin insulation, containing horizontal and vertical rows of electrodes that form a grid. Beneath the electrode layers is a circuit board to which the electrode layers are connected. The electrode layers are charged with a constant alternating current, such that, as a finger approaches the electrode grid, the current is interrupted and the interruption is detected by the circuit board. The initial location where the finger touches the surface is registered so that subsequent finger movements can be determined in relation to the initial point. The path corresponding to the finger movement on the surface of the touch pad 16 may be interpreted as a gesture, and a radio control command may be executed in response thereto. In addition, the touch pad 16 may also sense the time between, or frequency of taps on the touch pad 16 and accordingly interpret such taps or multiple finger movements together as a single gesture corresponding to a radio control command.

As the touch pad 16 senses various finger movements to recognize a gesture, the gesture may be sent to the radio tuner 12 and shown on the display 14. In one embodiment, a gesture including a substantially linear motion from the left to the right of the pad causes the radio tuner 12 to execute the radio control command to advance to the next station, either based on station number or based on memory presets. Alternatively, a gesture from the right to the left of the touch pad 16 advances the radio tuner 12 to the previous station. Similarly, a gesture moving from the bottom of the touch pad 16 to the top of the touch pad 16 may increase the volume, while a gesture moving from the top to the bottom of the touch pad 16 may lower the volume. Further, to avoid confusion with other gestures, the touch pad 16 may be configured, such that, volume gestures are only sensed along the edge of the touch pad 16.

Gestures may take the form of letters that correspond to the name of the radio command to be executed. For example, an “S” shaped gesture may be used to initiate a seek mode. Similarly, another “S” may be used to exit the seek mode. Memory presets may be accessed by entering an “M” shaped gesture followed by a gesture in the shape of the number of the preset (i.e. “1”, “2”, etc.). Similarly, a tune command may be executed by entering a “T” shaped gesture followed by a gesture in the shape of the station number. For example, a gesture corresponding to “T“, “1”, “0”, “3” on the touch pad 16 to execute a command that will tune to station 103. To avoid inadvertent gestures from being recognized, an “L” gesture may be used to lock the touch pad, so that, the touch pad will not recognize subsequent gestures until an unlock gesture, such as, the shape “U” has been entered.

Further, for a portable or even wearable radio, the ability to change orientation for a left or right-handed person is desirable. For example, a gesture in the shape of an up arrow by making a “\hat{ }” then a “|” may be used to set the orientation. The direction of the “\hat{ }” may be used to indicate the top of the touch pad 16. In addition, the touch pad 16 may have a guide 18, such as, shaped ridges to help orient the user, so they do not need to look at the device to enter gestures in the proper orientation.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A radio system for portable use, the radio system comprising:
a radio tuner to receive radio transmissions;
a display in communication with the radio tuner; and
a touch pad configured to sense a plurality of gestures made on a surface of the touch pad, the radio tuner being configured to execute a radio control command in response to each of the plurality of gestures.

2. The radio system according to claim 1, wherein the radio tuner is a satellite radio tuner.

3. The radio system according to claim 1, wherein the surface of the touch pad has indicia formed thereon to indicate orientation of the touch pad.

4. The radio system according to claim 1, wherein one of the plurality of gestures takes the form of a letter corresponding to the first letter of a radio control command.

5. The radio system according to claim 1, wherein the radio tuner is configured to advance to a next station in response to one of the plurality of gestures.

6. The radio system according to claim 5, wherein the radio tuner is configured to advance to a next station in response to a left to right or right to left gesture on the touch pad.

7. The radio system according to claim 1, wherein the radio tuner is configured to advance to a previous station in response to one of the plurality of gestures.

8. The radio system according to claim 1, wherein the radio tuner is configured to adjust volume of the radio tuner in response to volume gesture of the plurality of gestures.

9. The radio system according to claim 8, wherein the touch pad is configured to recognize the volume gesture only along the edge of the surface of the touch pad.

10. The radio system according to claim 8, wherein the radio tuner is configured to increase the volume in response to a gesture having a bottom to top motion on the surface of the touch pad.

11. The radio system according to claim 8, wherein the radio tuner is configured to decrease the volume in response to a gesture having a top to bottom motion on the surface of the touch pad.

12. The radio system according to claim 1, wherein the radio tuner is configured to enter a seek mode in response to one of the plurality of gestures.

13. The radio system according to claim 1, wherein the radio tuner is configured to enter a seek mode in response to an “S” shaped gesture on the touch pad.

14. The radio system according to claim 1, wherein the radio tuner is configured to exit a seek mode in response to one of the plurality of gestures.

15. The radio system according to claim 1, wherein the radio tuner is configured to exit a seek mode in response to an “S” shaped gesture on the touch pad.

16. The radio system according to claim 1, wherein the radio tuner is configured to lock the touch pad in response to one of the plurality of gestures.

17. The radio system according to claim 1, wherein the radio tuner is configured to lock the touch pad in response to an “L” shaped gesture on the touch pad.

18. The radio system according to claim 1, wherein the radio tuner is configured to unlock the touch pad in response to one of the plurality of gestures.

19. The radio system according to claim 1, wherein the radio tuner is configured to unlock the touch pad in response to a “U” shaped gesture on the touch pad.

20. The radio system according to claim 1, wherein the radio tuner is configured to tune to a desired station number in response to one of the plurality of gestures.

21. The radio system according to claim 1, wherein the radio tuner is configured to tune to a desired station number in response to a gesture including a generally “T” shaped motion followed by motions corresponding to a shape of each digit in the desired station number on the touch pad.

22. The radio system according to claim 1, wherein the radio tuner is configured to change a touch pad recognition orientation in response to one of the plurality of gestures.

23. The radio system according to claim 1, wherein the radio tuner is configured to change the touch pad recognition orientation in response to an arrow shaped gesture indicating a direction of desired orientation of the touch pad.
